(19) United States
(12) Patent Application Publication
(10) Pub. No.: US 2005/0251400 A1
(43) Pub. Date: Nov. 10, 2005

(54) Method for product condition verification

(76) Inventor: Getulio Perelli, Battle Creek, MI (US)

Correspondence Address: GIFFORD, KRASS, GROH, SPRINKLE & CITKOWSKI, P.C, PO BOX 7021, TROY, MI, 48007-7021, US

(21) Appl. No.: 10/842,391

(22) Filed: May 10, 2004

(51) Int. Cl. G06F 17/60

(52) U.S. Cl. 705/1; 705/9; 705/10

(57) ABSTRACT

A method for verification of the condition of a product at a remote location. The method includes the steps of identifying an inspector geographically near the product to be verified. A form having a checklist with criteria pertinent to the product to be verified is transmitted from a central location to the inspector. The inspector completes the form following examination of the product to be verified and then transmits the completed form to the central location.

### BACKGROUND OF THE INVENTION

I. Field of the Invention

The present invention relates to a method for verifying the condition of a product at a remote location.

II. Description of Related Art

With the advent of the World Wide Web, the purchase of products by consumers over the World Wide Web has become increasingly prevalent for a number of reasons. For example, the purchase of products over the World Wide Web allows a consumer to not only purchase products that may not be available locally to the consumer, but also enables the consumer to engage in comparative shopping and comparative pricing.

The purchase of products via the World Wide Web falls generally into three categories, namely new products, used products and real estate. The purchase of both used and new products and real estate over the World Wide Web each provides its own advantages and disadvantages.

The purchase of new products over the World Wide Web presents the least risk to the purchaser. In these cases, the condition of the products is known, i.e. the products are new. Furthermore, many such new products include a manufacturer warranty so that, in the event that the product is defective once received, the consumer generally has recourse to have the product repaired or replaced by the manufacturer. The disadvantage, however, of purchasing new products is that such products are generally more expensive than used products of the same type.

Conversely, the condition of used products, or products that cannot be moved, such as real estate, is that the condition of the product may vary from “almost” new to unacceptably damaged. Furthermore, even though photographs or other images of the product may be displayed on the World Wide Web at the time of purchase, it is difficult, if not altogether impossible, for the consumer to accurately determine the condition of the product prior to the time of purchase.

For all these reasons, when the consumer purchases a used product over the World Wide Web, the purchaser oftentimes must rely solely upon representations from the seller as to the condition of the goods. Such representations are oftentimes not only inaccurate, but in many cases fraudulent. When this occurs, the consumer purchases a product believing it to be in one condition and at a price representative of that condition. However, when the product is actually received, it may be in a much worse condition than represented by the seller so that the purchaser, in effect, has overpaid for the purchase.

### SUMMARY OF THE PRESENT INVENTION

The present invention provides a method which overcomes all of the above-mentioned disadvantages of purchasing products and/or real estate via the World Wide Web.

In brief, the method of the present invention comprises the first step of identifying an inspector who is geographically near a product to be verified. Although any means can be used to identify such inspectors, in many situations, fraternal organizations or employment organizations may be used to obtain lists of persons who are able to act as inspectors throughout the country.

After the inspector geographically near the product to be verified has been identified, a form having a checklist with criteria pertinent to the product to be inspected is transmitted from a central location to the inspector. Such forms will vary depending upon the precise type of product to be inspected. Furthermore, the form with the product checklist is preferably electronically sent to the inspector over the World Wide Web although other transmission means may alternatively be used.

After the inspector has received the form with the checklist criteria pertinent to the product to be inspected, the inspector, upon examination of the product, completes the form which verifies the condition of the product. Additionally, the inspector optionally will take photographs of the product to be inspected.

Thereafter, the inspector transmits the completed form and optionally photographs of the product inspected to the central location. Preferably, this transmission is via the World Wide Web although other means may alternatively be used.

After receipt at the central location of the completed form and, if present, images of the product inspected, the central location transmits the completed form and images, if present, to the consumer in advance of the completed purchase by the consumer of the product inspected. For this service, the consumer will pay a fee to the central location and a portion of that fee is then paid by the central location to the inspector.

### BRIEF DESCRIPTION OF THE DRAWING

A better understanding of the present invention will be had upon reference to the following detailed description, when read in conjunction with the accompanying drawing, wherein like reference characters refer to like parts throughout the several views, and in which:

FIG. 1 is a block diagrammatic view illustrating the operation of the method of the present invention; and

FIG. 2 is a flowchart illustrating the preferred embodiment of the method of the present invention.

### DETAILED DESCRIPTION OF A PREFERRED EMBODIMENT OF THE PRESENT INVENTION

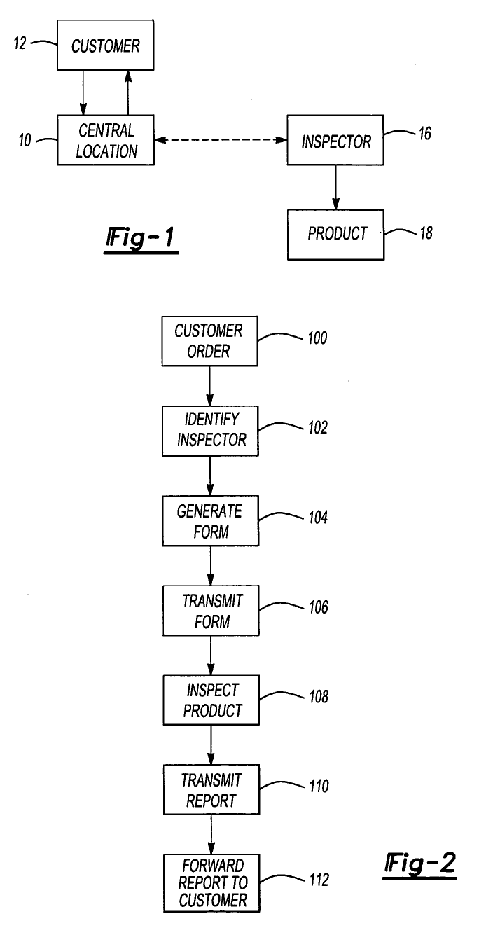

With reference first to FIG. 1, a block diagram illustrating the preferred method of the present invention is shown. In FIG. 1, a central location 10, which may be located geographically anywhere, receives an inquiry from a consumer 12 regarding the verification of the condition of a product 14 at a location geographically remote from the consumer 12. In order to obtain the product verification, the consumer 12 pays the central location 10 a fee which may be either a set fee per product 14, or a variable fee depending upon the type of product 14. Furthermore, the product 14 may comprise any type of goods or real estate.

After the central location 10 has received the inquiry from the consumer 12, the central location 10 electronically creates a form having a checklist which is customized with information and other criteria that are pertinent to the particular type of product 14 for which condition verification is desired. For example, if the product 14 to be verified is a piano, the form generated by the central location 10 may include a checklist item “Do all of the keys work?” Different types of products 14, of course, will have different checklists with different checklist items each of which set forth criteria that are customized to the particular type of product 14 to be inspected.

After completion of the form, the central location 10 transmits the form with the checklist to an inspector 16 who is geographically near the product 14 for which the verification of the condition of the product 14 is desired. Although any means can be used by the central station to transmit the form to the inspector 16, preferably, the form is transmitted electronically by facsimile or electronically over the World Wide Web.

Any conventional means may be utilized to identify inspectors 16 that are geographically near products across the United States. For example, fraternal organizations and work organizations, such as police associations, may be used to identify potential inspectors capable and willing to inspect products for which the verification of the product condition is desired.

After the inspector 16 receives the form with the checklist customized with criteria pertinent to the product 14 to be inspected, the inspector 16 conducts a physical interview of the product 14. During that examination, the inspector 16 completes the checklist provided on the form from central station 10 thus verifying the condition of the product 14. Optionally, the inspector 16 also takes photographs of the product 14.

Following the inspection of the product 14, the inspector 16 then transmits the completed form and optionally the photographs of the product 14 back to the central station 10. The central station 10 then forwards the report on to the consumer 12 and also pays a fee to the inspector 16.

An important feature of the method of the present invention is that neither the central station 10 nor the inspector guarantees or warrants the product 14 in any way. Rather, the central station 10 and inspector 16 merely provide information to the consumer 12 relating to the condition of the product during that inspection. It is then entirely the consumer's decision whether or not to proceed forward with the purchase of the product 14.

With reference now to FIG. 2, the method of the present invention is summarized in flowchart format. At step 100, the consumer contacts the central station 10 and requests an inspection of a geographically remote product from the central station 10. The consumer provides all of the necessary details regarding the location of the product to be inspected and also pays a fee to the central station 10.

At step 102, the central station identifies an inspector in an area geographically near the product to be inspected. Typically, the central station 10 will maintain lists of potential inspectors across the entire United States so that an inspector can be identified regardless of the geographical location of the product 14.

At step 104, the central location generates a form with a checklist having criteria pertinent to the product to be inspected. In practice, the central location will maintain an inventory of forms relating to various products and then simply select the relevant form for the particular product to be inspected.

At step 106, the central location 10 transmits the form to the inspector 16. The inspector 16 then physically inspects the product at step 108 and optionally takes digital photographs of the product under inspection.

Following completion of the inspection, at step 110 the inspector 16 then transmits the completed form to the central station 10 together with the photographs of the product inspected. In return for this, the central station 10 pays a fee to the inspector 16.

Lastly, at step 112, the central station provides the completed form with the checklist to the consumer 12 thus completing the transaction. Whether or not the consumer 12 actually proceeds forward with the purchase of the product 14, however, is strictly the decision of the consumer 12.

From the foregoing, it can be seen that the present invention provides a simple and yet highly effective means for verification of products that are at geographically remote locations. Having described my invention, however, many modifications thereto will become apparent to those skilled in the art to which it pertains without deviation from the spirit of the invention as defined by the scope of the appended claims.

1. A method for verification of product condition for any of a plurality of different products at a remote location comprising the steps of:
identifying an inspector geographically near a product to be verified,
transmitting a form having a checklist having criteria pertinent to the product to be verified from a central location to the inspector,
the inspector completing the form upon examination of the product to be verified,
the inspector transmitting the completed form to the central location.

2. The invention as defined in claim 1 where said transmitting steps each comprise transmitting the form electronically.

3. The invention as defined in claim 1 where said transmitting steps each comprise transmitting the form via the World Wide Web.

4. The invention as defined in claim 1 where said step of transmitting the completed form further comprises the step of transmitting images of the product to be verified.

5. The invention as defined in claim 4 wherein said step of transmitting images of the product to be verified comprises the step of transmitting the images electronically.

6. The invention as defined in claim 4 wherein said step of transmitting images of the product to be verified comprises the step of transmitting the images via the World Wide Web.
